(19) United States
(12) Patent Application Publication
(10) Pub. No.: US 2023/0146356 A1
(43) Pub. Date: May 11, 2023

(54) TRANSMISSION DEVICE AND COMMUNICATION SYSTEM

(71) Applicant: Mitsubishi Electric Corporation, Tokyo (JP)

(72) Inventors: Kiyomi TAKEI, Tokyo (JP); Masanori NAKATA, Tokyo (JP)

(21) Appl. No.: 17/916,444

(22) PCT Filed: Jun. 5, 2020
(86) PCT No.: PCT/JP2020/022243

§ 371 Date: Sep. 30, 2022

(51) Int. Cl. H04L 47/24; H04L 12/28; H04L 1/08

(52) U.S. Cl. CPC H04L 47/24; H04L 12/2807; H04L 1/08

(57) ABSTRACT

A transmission apparatus includes a controller that processes data that is transmitted in communication between the communication module and a reception device. The controller extracts data from transmission-scheduled data and produces a transmission-scheduled data list. When data communication between the transmission apparatus and the reception device is interrupted and is then recovered, and an interruption history of the communication is present in the reception device, the controller acquires from the reception device, an unreceived data list indicating data that is not received by the reception device before the communication is interrupted. The controller combines the acquired unreceived data list with the produced transmission-scheduled data list to update the transmission-scheduled data list. The communication module transmits the updated transmission-scheduled data list to the reception device, and transmits the transmission-scheduled data corresponding to the transmission-scheduled data list to the reception device after transmitting the updated transmission-scheduled data list.

### TECHNICAL FIELD

The present disclosure relates to a transmission device and a communication system that can resume data communication after the data communication is interrupted and is recovered.

### BACKGROUND ART

In some existing communication systems, a transmission device first transmits a transmission-scheduled data list of transmission data to a reception device, and then performs data communication. In such a communication system, when the data communication is interrupted by some communication failure, the communication system cannot determine, of data listed in the transmission-scheduled data list, which data has been transmitted in communication (for example, see Patent Literature 1).

### CITATION LIST

### Patent Literature

Patent Literature 1: Japanese Unexamined Patent Application Publication No. 2007-174247

### SUMMARY OF INVENTION

### Technical Problem

In the existing communication system using the transmission-scheduled data list, if the data communication is interrupted, the transmission device performs transmission from first transmission data of the transmission-scheduled data list, or performs transmission from transmission data of the transmission-scheduled data list designated by a user in a reception device.

Therefore, in the existing communication system, the communication volume of transmission data is increased and communication time of transmission data is long.

The present disclosure is made in consideration of the above circumstances, and relates to a transmission device and a communication system that can reduce, even if data communication is interrupted, the communication volume of transmission data in re-transmission, and reduce a communication time necessary for the re-transmission.

### Solution to Problem

A transmission device according to an embodiment of the present disclosure includes: a communication module configured to communicate with a reception device through transmission of data; and a controller configured to process data that is transmitted in communication between the communication module and the reception device. The controller is configured to extract data from transmission-scheduled data and produce a transmission-scheduled data list. The controller is configured to acquire from the reception device, when data communication between the transmission apparatus and the reception device is interrupted and is then recovered, and an interruption history of the communication is present in the reception device, an unreceived data list indicating data that is not received by the reception device before the communication is interrupted. The controller is configured to combine the acquired unreceived data list with the produced transmission-scheduled data list to update the transmission-scheduled data list. The communication module is configured to transmit the updated transmission-scheduled data list to the reception device, and transmit the transmission-scheduled data corresponding to the transmission-scheduled data list to the reception device after transmitting the updated transmission-scheduled data list.

### Advantageous Effects of Invention

According to the embodiment of the present disclosure, the controller produces the transmission-scheduled data list from data to be transmitted. When data communication is interrupted and is then recovered, and the interruption history of the communication is present in the reception device, the controller acquires, from the reception device, the unreceived data list indicating data that is not received by the reception device before the communication is interrupted. The controller combines the acquired unreceived data list with the produced transmission-scheduled data list to update the transmission-scheduled data list. Furthermore, the controller transmits the transmission-scheduled data corresponding to the transmission-scheduled data list to the reception device, after transmitting the updated transmission-scheduled data list to the reception device. As a result, even in the case where data communication between the transmission device and the reception device is interrupted, the controller can transmit the transmission-scheduled data in the middle of the data communication, since the updated transmission-scheduled data list can be used. Therefore, the transmission device can reduce the communication volume of transmission data related to re-transmission, and can reduce the communication time necessary for the transmission data related to the re-transmission.

### BRIEF DESCRIPTION OF DRAWINGS

FIG. 1 is a diagram illustrating a data acquisition device and an air-conditioning apparatus in a communication system according to an embodiment

FIG. 2 is a diagram to explain functions of a controller of the data acquisition device in the communication system according to the embodiment.

FIG. 3 is a diagram to explain functions of a controller of the air-conditioning apparatus in the communication system according to the embodiment.

FIG. 4 is a flowchart to explain operation of the data acquisition device in the communication system according to the embodiment.

FIG. 5 is a flowchart to explain operation of the air-conditioning apparatus in the communication system according to the embodiment.

FIG. 6 is a diagram to explain data flow between the data acquisition device and the air-conditioning apparatus in the communication system according to the embodiment.

FIG. 7 is a diagram illustrating data stored in a memory of the controller of the air-conditioning apparatus in the communication system according to the embodiment,

FIG. 8 is a diagram illustrating a transmission-scheduled data list created by a list data extraction module of the air-conditioning apparatus in the communication system according to the embodiment.

FIG. 9 is a diagram illustrating a transmission-scheduled data list of Modification 1 created by the list data extraction module of the air-conditioning apparatus in the communication system according to the embodiment.

FIG. 10 is a diagram illustrating a transmission-scheduled data list of Modification 2 created by the list data extraction module of the air-conditioning apparatus in the communication system according to the embodiment.

FIG. 11 is a diagram illustrating a transmission-scheduled data list of Modification 3 created by the list data extraction module of the air-conditioning apparatus in the communication system according to the embodiment.

### DESCRIPTION OF EMBODIMENTS

A communication system according to an embodiment will be described with reference to the drawings. It should be noted that in each of figures, components that are the same as those in a previous figure or previous figures are denoted by the same reference sings, and numerals in the drawings, and after they are each described once, their descriptions will not be re-applied, except for when the necessity arises, The present disclosure can include all possible combinations of configurations described regarding the following embodiment.

### Embodiment

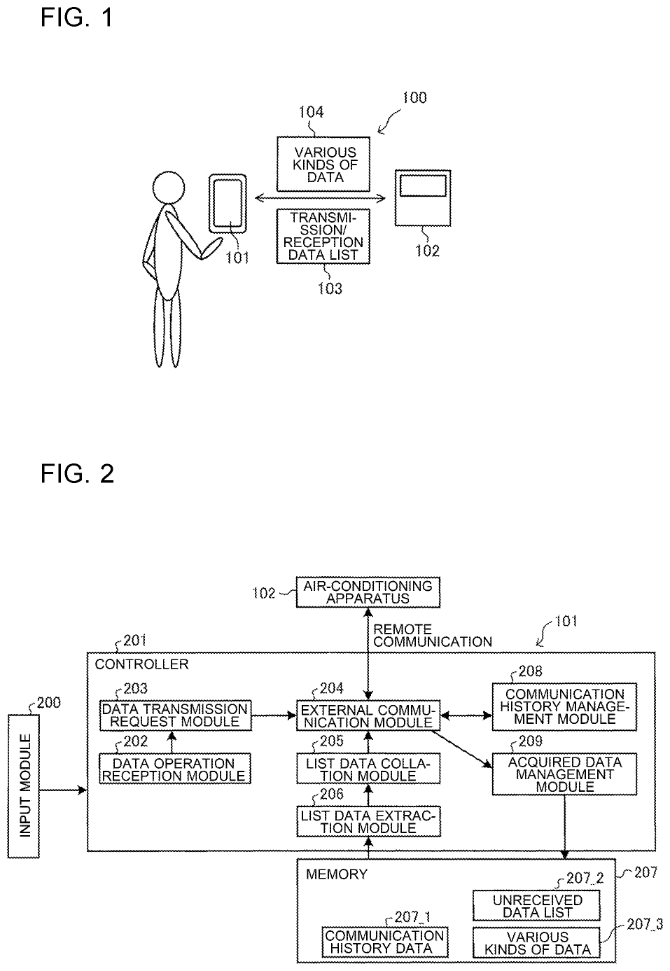

FIG. 1 is a diagram illustrating a data acquisition device 101 and an air-conditioning apparatus 102 in a communication system 100 according to the embodiment.

As illustrated in FIG. 1, the communication system 100 includes the data acquisition device 101 and the air-conditioning apparatus 102.

The data acquisition device 101 is an information terminal such as a smartphone, a desktop PC, a notebook PC, and a tablet PC.

The air-conditioning apparatus 102 transmits data to the data acquisition device 101.

The air-conditioning apparatus 102 is a transmission apparatus that transmits data, and the data acquisition device 101 is a reception device that receives the data from the air-conditioning apparatus 102.

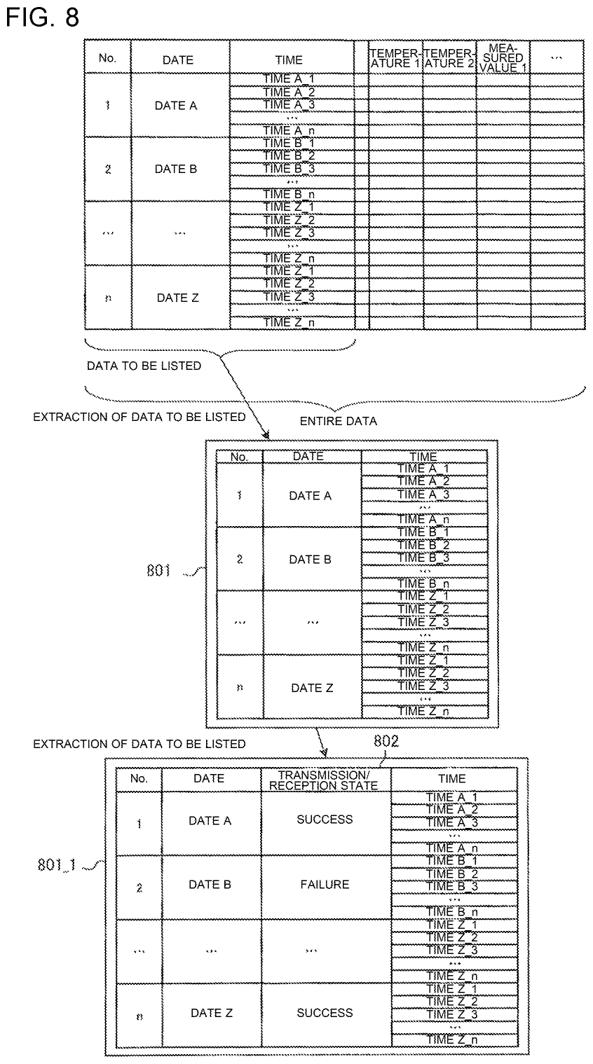

In communication between the data acquisition device 101 and the air-conditioning apparatus 102, a transmission and reception data list 103 is transmitted between the data acquisition device 101 and the air-conditioning apparatus 102. The transmission and reception data list 103 includes a transmission-scheduled data list 801 (see FIG. 8) extracted and produced from data on the air-conditioning apparatus 102, and an unreceived data list 207_2 (see FIG. 2) in the data acquisition device 101.

Furthermore, the air-conditioning apparatus 102 transmits various kinds of data 104 to the data acquisition device 101. The various kinds of data 104 are, for example, a data acquisition date and time, an indoor temperature, an external air temperature, an opening degree of a LEV (expansion valve), a pipe temperature at a heat exchanger, a discharge pressure, a suction pressure, a discharge temperature, a suction temperature at a compressor, and parameters of subcooling and superheating.

FIG. 2 is a diagram for explanation of functions of a controller 201 of the data acquisition device 101 in the communication system 100 according to the embodiment.

As illustrated in FIG. 2, the controller 201 of the data acquisition device 101 is connected to an input module 200 and a memory 207.

The input module 200 is a device that does input to the data acquisition device 101, and for example, a touch panel or a mouse.

The memory 207 stores communication history data 207_1, the unreceived data list 207_2, various kinds of data 207_3 received from the air-conditioning apparatus 102, etc. The communication history data 207_1 is data indicating a communication history at time at which communication is interrupted, and is recorded for each data. The unreceived data list 207_2 indicates data that has not yet been received by the data acquisition device 101.

The controller 201 includes a data operation reception module 202, a data transmission request module 203, an external communication module 204, a list data collation module 205, a list data extraction module 206, a communication history management module 208, and an acquired data management module 209.

The data operation reception module 202 receives a request for data transmission that is input from the input module 200.

The data transmission request module 203 makes the request for data transmission that is received by the data operation reception module 202 to the external communication module 204.

The external communication module 204 transmits data such as the unreceived data list 207_2, the transmission-scheduled data list 801, and the various kinds of data 104 to the air-conditioning apparatus 102, and in addition, transmits the request for data transmission from the data transmission request module 203, etc. to the air-conditioning apparatus 102.

The list data extraction module 206 extracts only data to be listed, from received data stored in the memory 207 (see FIG. 8).

The list data collation module 205 collates list items of the unreceived data list 207_2 and list items of the transmission-scheduled data list 80 transmitted from the air-conditioning apparatus 102 with each other.

The acquired data management module 209 stores in the memory 207, various kinds of data acquired from the air-conditioning apparatus 102 via the external communication module 204.

The communication history management module 208 stores in the memory 207, a communication history at time at which communication is interrupted.

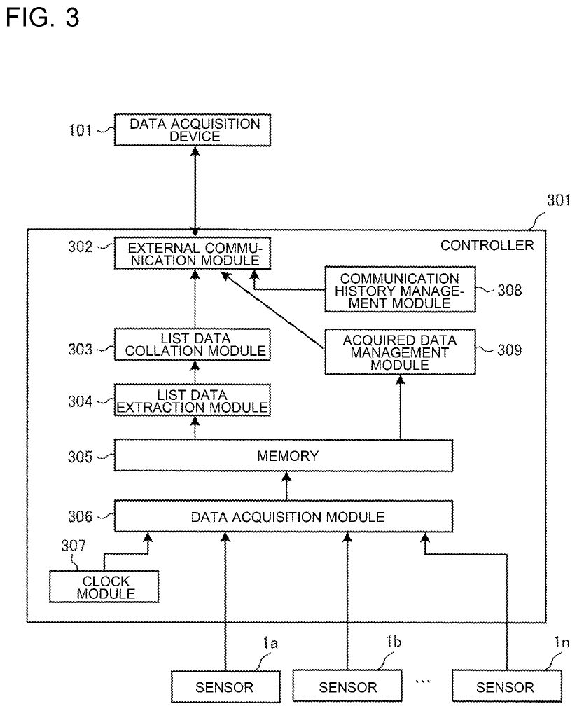

FIG. 3 is a diagram for explanation of functions of a controller 301 of the air-conditioning apparatus 102 in the communication system 100 according to the embodiment.

Referring to FIG. 3, the controller 301 of the air-conditioning apparatus 102 includes an external communication module 302, a list data collation module 303, a list data extraction module 304, a memory 305, a data acquisition module 306, a clock module 307, a communication history management module 308, and an acquired data management module 309.

As illustrated in FIG. 3, the controller 301 is connected to a sensor 1a, a sensor 1b, . . . , and a sensor 1n.

The clock module 307 outputs time to be referred to in order that data from the sensor 1a, the sensor 1b, . . . , and the sensor 1n be provided as time-series data.

The data acquisition module 306 acquires various kinds of data from the sensor 1a, the sensor 1b, . . . , and the sensor 1n, and the time from the dock module 307.

The memory 305 stores the time acquired from the dock module 307 and the various kinds of data acquired by the data acquisition module 306, on a time series basis.

The list data extraction module 304 acquires data for the transmission-scheduled data list 801, from the various kinds of data stored in the memory 305, and produces the transmission-scheduled data list 801.

The list data collation module 303 collates list items of the transmission-scheduled data list 801 produced by the list data extraction module 304 and list items of the unreceived data list 207_2 received from the data acquisition device 101 with each other.

The external communication module 302 transmits the unreceived data list 207_2, the transmission-scheduled data list 801, the various kinds of data 104, etc., to the data acquisition device 101. The communication history management module 308 stores in the memory 305, a communication history at time at which the communication is interrupted.

The acquired data management module 309 transfers the various kinds of data 104 stored in the memory 305 to the external communication module 302.

It should be noted that the controller 301 as illustrated in FIG. 3 is dedicated hardware or a central processing unit (CPU, also referred to as a central processing device, a processing device, an arithmetic device, a microprocessor, a microcomputer, or a processor) that executes a program stored in a memory. In the case where the controller 301 is the dedicated hardware, the controller 301 corresponds to, for example, a single circuit, a composite circuit, an application specific integrated circuit (ASIC), a field programmable gate array (FPGA), or a combination thereof. Functional modules whose functions are fulfilled by the controller 301 may be respective hardware, or may be single hardware. In the case where the controller 301 is the CPU, functions that are fulfilled by the controller 301 are fulfilled by software, firmware, or a combination of software and firmware. The software and the firmware are written as programs and stored in the memory 305. The CPU fulfills the functions of the controller 301 by reading out and executing the programs stored in the memory 305. The memory is, for example, a nonvolatile or volatile semiconductor memory such as a RAM, a ROM, a flash memory, an EPROM, and an EEPROM. It should be noted that part of the functions of the controller 301 may be fulfilled by dedicated hardware, and the other part of the functions may be fulfilled by software or firmware.

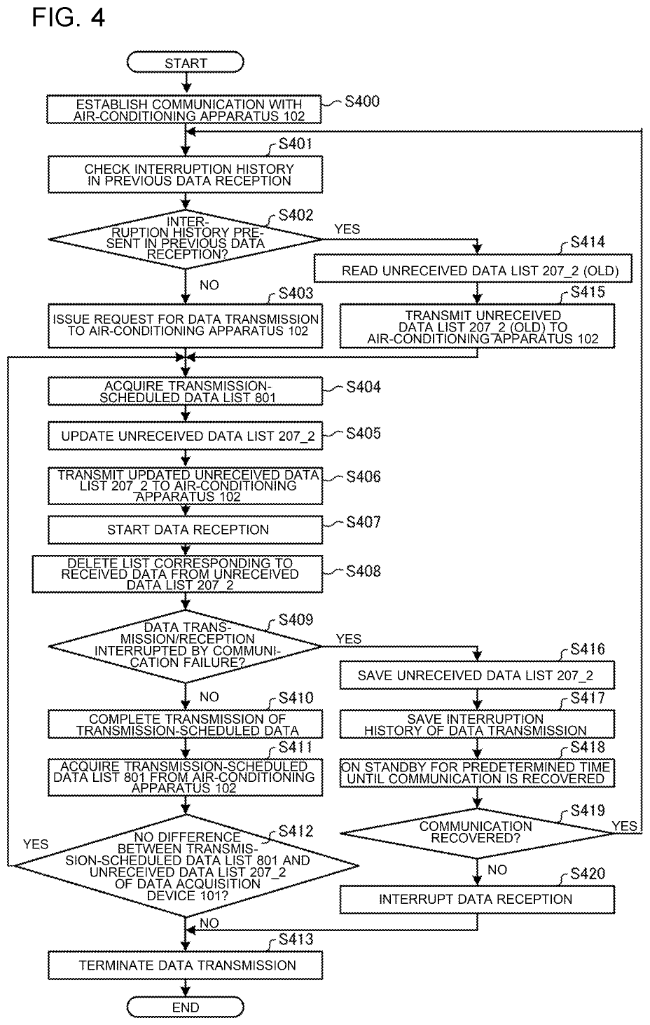

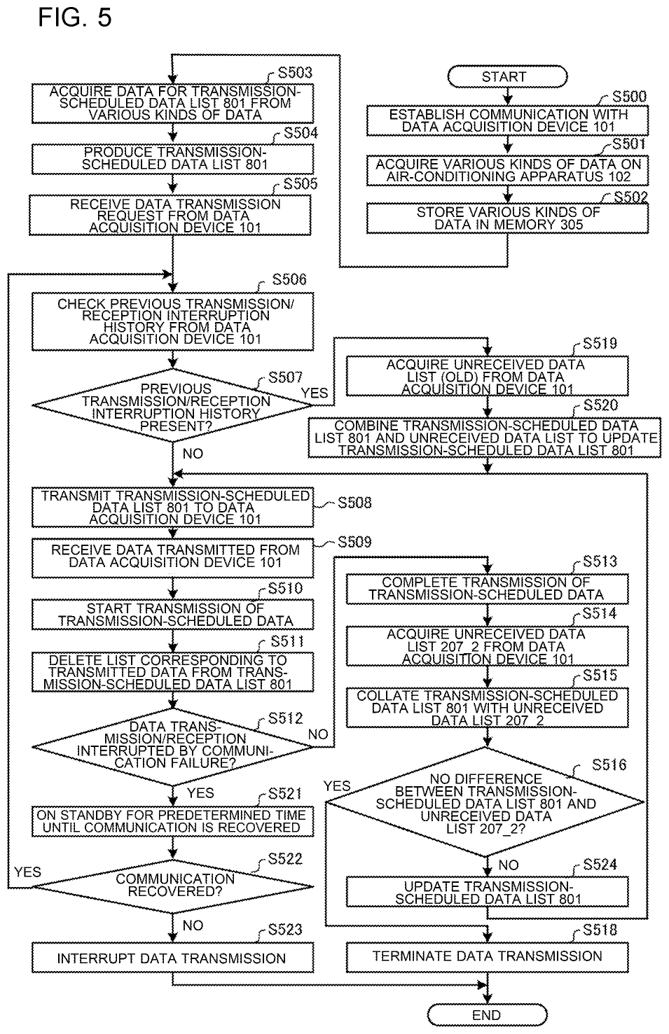

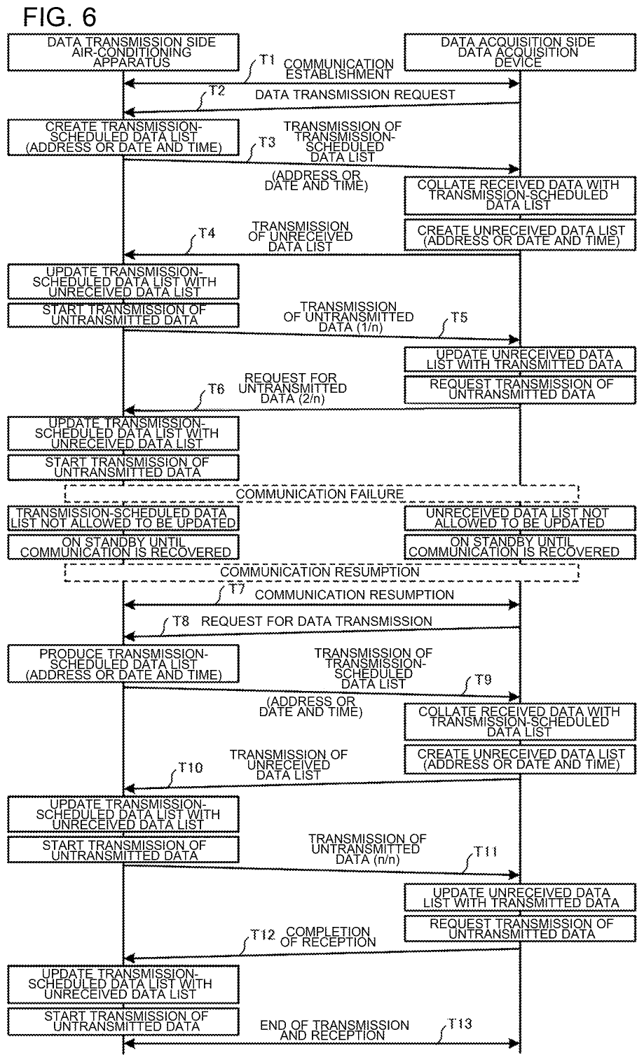

Next, an operation of the communication system 100 according to the embodiment will be described. FIG. 4 is a flowchart for explanation of an operation of the data acquisition device 101 in the communication system 100 according to the embodiment. FIG. 5 is a flowchart for explanation of an operation of the air-conditioning apparatus 102 in the communication system 100 according to the embodiment. FIG. 6 is a diagram for an explanation of the flow of data between the data acquisition device 101 and the air-conditioning apparatus 102 in the communication system 100 according to the embodiment.

First of all, an operation of the data acquisition device 101 will be described with reference to FIG. 4.

As illustrated in FIG. 4, the controller 201 of the data acquisition device 101 establishes communication with the air-conditioning apparatus 102 (step S400), and then checks an interruption history in previous data reception on the basis of the communication history data 207_1 stored in the memory 207 (step S401).

Subsequently, the controller 201 determines whether or not an interruption history is present for each of data in the previous data reception (step S402). When the controller 201 determines in step S402 that an interruption history in the previous data reception is present (YES in step S402), the controller 201 reads the unreceived data list 207_2 prior to interruption, which is stored in the memory 207 (step S414). Of the read unreceived data list 207_2 prior to the interruption, unreceived data list 207_2 including data the communication history of which includes record of “failure” is transmitted from the controller 201 to the air-conditioning apparatus 102 (step S415).

In contrast, when determining in step S402 that an interruption history in the previous data reception is absent (NO in step S402), the controller 201 issues a request for data transmission to the air-conditioning apparatus 102 (step S403).

After step S403, after step S415, or after it is determined that the answer to the question in step S412 is YES, the controller 201 acquires the transmission-scheduled data list 801 from the air-conditioning apparatus 102 (step S404).

Subsequently, the controller 201 removes received data from the unreceived data list 207_2 stored in the memory 207 of the data acquisition device 101, thereby updating the unreceived data list 207_2 (step S405).

The controller 201 transmits the updated unreceived data list 207_2 to the air-conditioning apparatus 102 (step S406). Then, the controller 201 receives data corresponding to the transmitted unreceived data list 207_2, from the air-conditioning apparatus 102 (step S407).

Thereafter, the controller 201 deletes a list corresponding to the received data, from the unreceived data list 207_2 (step S408).

Subsequently, the controller 201 determines whether data communication is interrupted by a communication failure or not (step S409). When determining in step S409 that data communication is interrupted by a communication failure (YES in step S409), the controller 201 temporarily saves in the memory 207, an unreceived data list 207_2 reflecting the above determination (step S416). Next, the controller 201 records “success” or “failure” as a communication state for each data, in the unreceived data list 207_2 as in a transmission-scheduled data list 801_1 as indicated in FIG. 8 (step S417).

Thereafter, the controller 201 is caused to be on standby for a predetermined time until communication is recovered (step S418), and determines whether the communication is recovered or not (step S419). When the controller 201 determines in step S419 that the communication is recovered (YES in step S419), the processing returns to step S401. By contrast, when determining in step S419 that the communication is not recovered (NO in step S419), the controller 201 interrupts the data reception (step S420), and ends data transmission (step S413). It should be noted that the data to be received is the various kinds of data 104 from the air-conditioning apparatus 102.

In contrast, when determining in step S409 that data communication is not interrupted by a communication failure (NO in step S409), the controller 201 completes transmission of the transmission-scheduled data (step S410), and acquires the transmission-scheduled data list 801 from the air-conditioning apparatus 102 (step S411).

Then, the controller 201 determines whether or not the transmission-scheduled data list 801 and the unreceived data list 207_2 of the data acquisition device 101 are not different from each other (step S412). When the controller 201 determines in step S412 that the transmission-scheduled data list 801 and the unreceived data list 207 2 of the data acquisition device 101 are not different from each other (YES in step S412), the processing returns to step S404. By contrast, when determining that the transmission-scheduled data list 801 and the unreceived data list 207_2 of the data acquisition device 101 are different from each other (NO in step S412), the controller 201 ends the data transmission (step S413).

Next, an operation of the air-conditioning apparatus 102 will be described with reference to FIG. 5.

As illustrated in FIG. 5, the controller 301 of the air-conditioning apparatus 102 establishes communication with the data acquisition device 101 (step S500), and then acquires various kinds of data from the sensor 1a, the sensor 1b, . . . , and the sensor 1n, and also acquires the time from the dock module 307 (step S501).

In FIG. 6, communication establishment at timing T1 corresponds to step S400 in FIG. 4 and step S500 in FIG. 5. Request for data transmission at timing T2 corresponds to step S403 in FIG. 4 and step S505 in FIG. 5. Transmission of a transmission-scheduled data list at timing T3 corresponds to step S404 in FIG. 4 and step S508 in FIG. 5. Transmission of an unreceived data list at timing T4 corresponds to step S406 in FIG. 4 and step S509 in FIG. 5. Transmission of untransmitted data (1/n) at timing T5 corresponds to step S407 in FIG. 4 and step S510 in FIG. 5. Request for untransmitted data (2/n) at timing T6 corresponds to step S406 in FIG. 4 and step S509 in FIG. 5. Resumption of communication at timing T7 corresponds to step S419 in FIG. 4 and step S522 in FIG. 5. Request for data transmission at timing T8 corresponds to step S403 in FIG. 4 and step S505 in FIG. 5. Transmission of a transmission-scheduled data list at timing T9 corresponds to step S404 in FIG. 4 and step S508 in FIG. 5. Transmission of an unreceived data list at timing T10 corresponds to step S406 in FIG. 4 and step S509 in FIG. 5. Transmission of untransmitted data (n/n) at timing T11 corresponds to step S407 in FIG. 4 and step S510 in FIG. 5. Completion of reception at timing T12 corresponds to step S412 in FIG. 4 and step S513 in FIG. 5. End of transmission and reception at timing T13 corresponds to step S413 in FIG. 4 and step S518 in FIG. 5.

Next, the controller 301 stores in the memory 305, the various kinds of data and the time acquired in step S501, on a time-series basis (step S502).

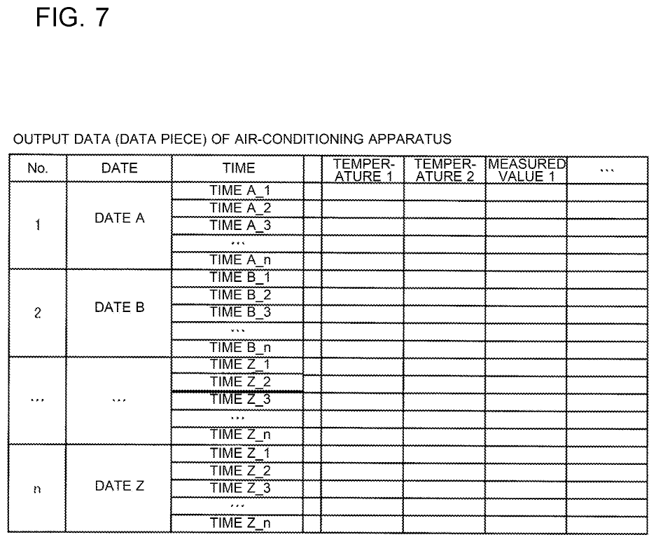

FIG. 7 is a diagram illustrating the data stored in the memory 305 of the controller 301 of the air-conditioning apparatus 102 in the communication system 100 according to the embodiment. As illustrated in FIG. 7, in the data stored in the memory 305, to dates, respective numbers are assigned. For a plurality of pieces of data acquired at the same date, respective times are indicated, The plurality of pieces of data are stored on a time-series basis. In FIG. 7, temperature_1, temperature _2, measured value_1, . . . are indicated as acquired data. FIG. 7 is a diagram indicating the entire data transmitted between the data acquisition device 101 and the air-conditioning apparatus 102.

The controller 301 acquires data for the transmission-scheduled data list 801 from the various kinds of data stored in the memory 305 (step S503), and produces the transmission-scheduled data list 801 indicating data to be transmitted (step S504). Then, the controller 301 receives a request for data transmission from the data acquisition device 101 (step S505).

FIG. 8 is a diagram illustrating the transmission-scheduled data list 801 produced by the list data extraction module 304 of the air-conditioning apparatus 102 in the communication system 100 according to the embodiment. As illustrated in FIG. 8, in the transmission-scheduled data list 801, numbers, dates, and times are indicated as data listed from the entire data as illustrated in FIG. 7. To the dates, the respective numbers are assigned. For the pieces of data, the respective times are indicated. transmission-scheduled data list 801_1 is obtained by adding an item 802 indicating a communication state, to the transmission-scheduled data list 801. In the item 802, a communication state is written as data by the communication history management module 308 when the data communication is interrupted.

Next, the controller 301 checks a previous communication interruption history from the data acquisition device 101 (step S506). The controller 301 determines whether or not the previous communication interruption history is present (step S507).

When determining in step S507 that the previous communication interruption history is present (YES in step S507), the controller 301 acquires unreceived data prior to interruption of the communication, from the data acquisition device 101 (step S519).

Thereafter, the controller 301 combines the transmission-scheduled data list 801 and the unreceived data list 207_2 to update the transmission-scheduled data list 801 (step S520). The unreceived data list 207_2 includes only data that is not received by the data acquisition device 101.

When the result of the determination in step S507 is NO, when the transmission-scheduled data list 801 is updated in step S520, and when the result of the determination in step S516 is NO, the controller 301 transmits the transmission-scheduled data list 801 to the data acquisition device 101 (step S508).

Thereafter, the controller 301 receives data transmitted from the data acquisition device 101 (step S509).

Next, the controller 301 starts transmission of transmission-scheduled data corresponding to the transmission-scheduled data list 801 or the updated transmission-scheduled data list 801 (step S510).

Thereafter, the controller 301 deletes a list corresponding to the transmitted data from the transmission-scheduled data list 801 (step S511).

Subsequently, the controller 301 determines whether or not data communication is interrupted by a communication failure (step S512). When determining that data communication is interrupted by a communication failure (YES in step S512), the controller 301 is caused to be on standby for a predetermined time until the communication is recovered (step S521), and determines whether or not the communication is recovered (step S522), When the controller 301 determines in step S522 that the communication is recovered (YES in step S522), the processing returns to step S500. By contrast, when the controller 301 determines that the communication is not been recovered (NO in step S522), the controller 301 interrupts the data transmission (step S523), and ends the processing.

By contrast, when determining that data communication is not interrupted by a communication failure (NO in step S512), the controller 301 completes transmission of the transmission-scheduled data corresponding to the transmission-scheduled data list 801 or the updated transmission-scheduled data list 801 (step S513).

Thereafter, the controller 301 acquires the unreceived data list 207_2 from the data acquisition device 101 (step S514). The structure of the unreceived data list 207_2 is the same as that of each of the transmission-scheduled data list 801_1, a transmission-scheduled data list 901_1, a transmission-scheduled data list 1001_1, and a transmission-scheduled data list 1101_1, and is a list structure in which a transmission and reception structure is recorded. Subsequently, the controller 301 collates the transmission-scheduled data list 801 or the updated transmission-scheduled data list 801 with the unreceived data list 207_2 (step S515).

Next, the controller 301 determines whether or not the transmission-scheduled data list 801 is not different from the unreceived data list 207_2 from the data acquisition device 101 (step S516). When determining that the transmission-scheduled data list 801 is not different from the unreceived data list 207_2 from the data acquisition device 101 (YES in step S516), the controller 301 ends the data transmission (step S518).

By contrast, when determining that the transmission-scheduled data list 801 is different from the unreceived data list 207_2 from the data acquisition device 101 (NO in step S516), the controller 301 reflects different part between those data lists in the transmission-scheduled data list 801, thereby updating the transmission-scheduled data list 801 (step S524), and the processing then returns to step S508.

### Modification 1

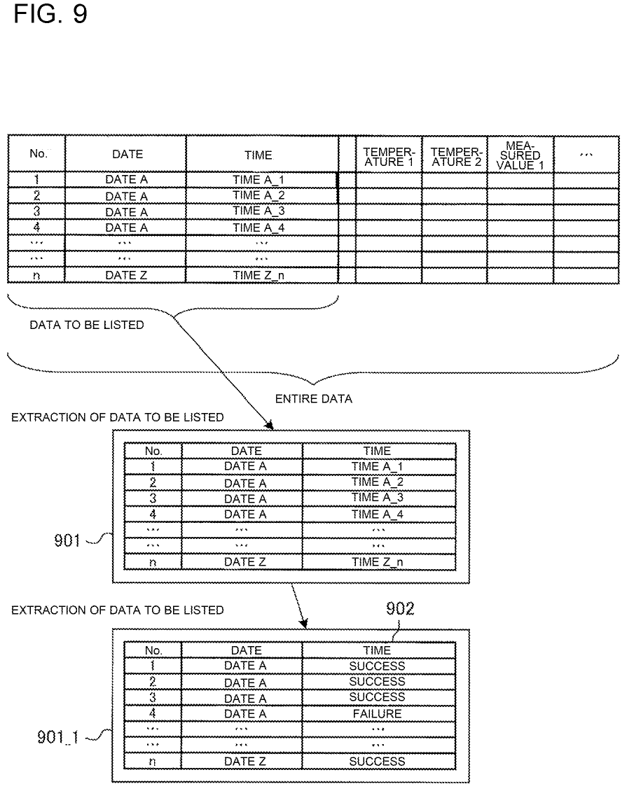

As the transmission-scheduled data list, a transmission-scheduled data list 901 as illustrated in FIG. 9 may be used instead of the transmission-scheduled data list 801 as illustrated in FIG. 8. FIG. 9 is a diagram illustrating the transmission-scheduled data list 901 of Modification 1 that is produced by the list data extraction module 304 of the air-conditioning apparatus 102 in the communication system 100 according to the embodiment.

As illustrated in FIG. 9, in the transmission-scheduled data list 901, numbers and dates are indicated as data pieces which are obtained at intervals of sampling of various kinds of data, The transmission-scheduled data list 901_1 is obtained by adding an item 902 indicating a communication state, to the transmission-scheduled data list 901. In the item 902, a communication data is written by the communication history management module 308 when data communication is interrupted.

### Modification 2

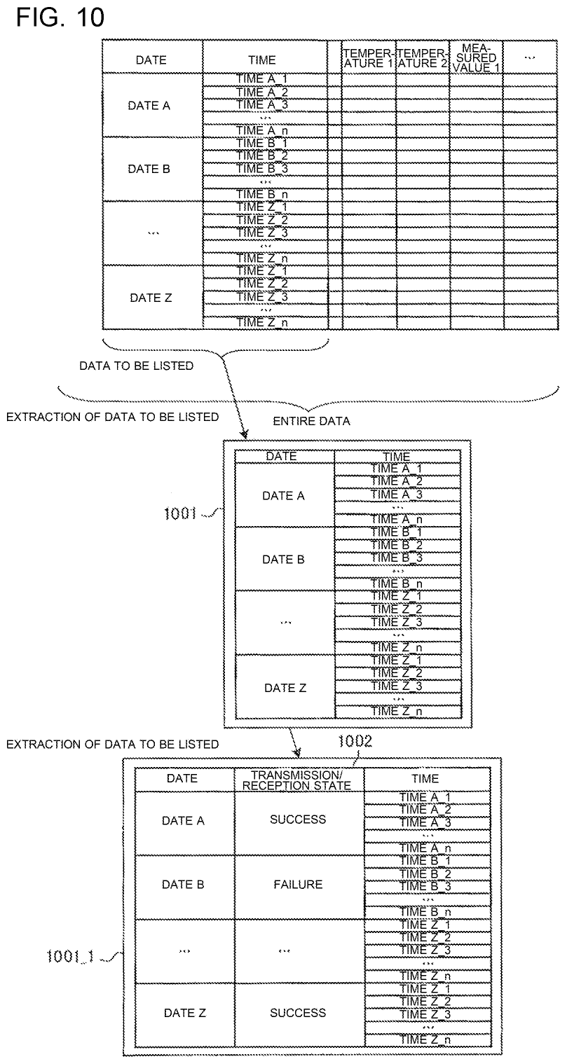

As the transmission-scheduled data list, a transmission-scheduled data list 1001 as illustrated in FIG. 10 may be used instead of the transmission-scheduled data list 801 as illustrated in FIG. 8. FIG. 10 is a diagram illustrating a transmission-scheduled data list 1001 of Modification 2 that is produced by the list data extraction module 304 of the air-conditioning apparatus 102 in the communication system 100 according to the embodiment.

As illustrated in FIG. 10, unlike the transmission-scheduled data list 801 as illustrated in FIG. 8, in the transmission-scheduled data list 1001, for data, respective dates are indicated; that is, to the data, respective numbers are not assigned. The transmission-scheduled data list 1001_1 is obtained by adding an item 1002 indicating a communication state, to the transmission-scheduled data list 1001. In the item 1002, a communication state is written by the communication history management module 308 when data communication is interrupted. The transmission-scheduled data list 1001 having such a structure can be used in the case where the number of management target devices is one. It should be noted that in place of a numerical value, for example, a unit number or a model number can be used as the number.

### Modification 3

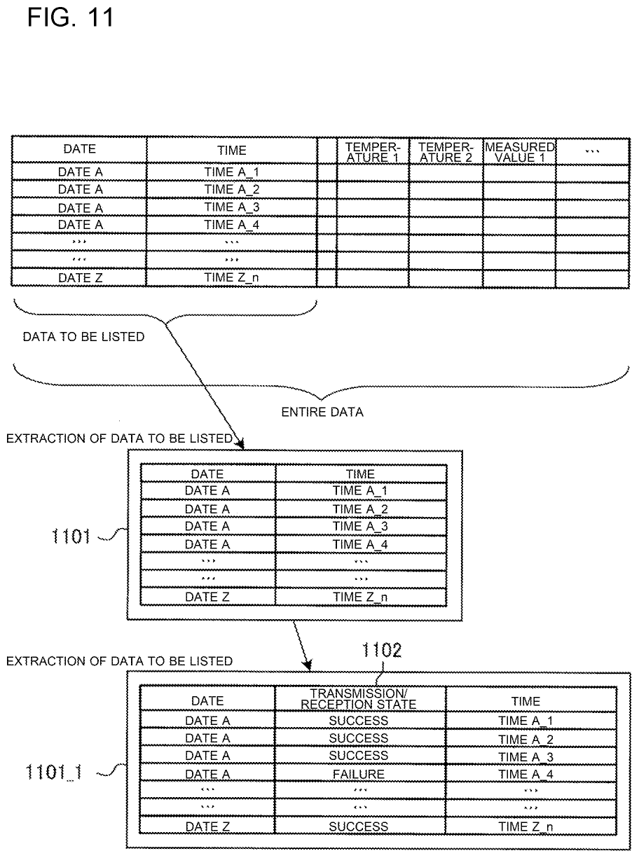

As the transmission-scheduled data list, a transmission-scheduled data list 1101 as illustrated in FIG. 11 may be used as the transmission-scheduled data list 901 as illustrated in FIG. 9. FIG. 11 is a diagram illustrating the transmission-scheduled data list 1101 of Modification 3 that is produced by the list data extraction module 304 of the air-conditioning apparatus 102 in the communication system 100 according to the embodiment.

As illustrated in FIG. 11, unlike the transmission-scheduled data list 901 as illustrated in FIG. 9, in the transmission-scheduled data list 1101, for data, respective dates are indicated; that is, to the data, respective numbers are not assigned. The transmission-scheduled data list 1101_1 is obtained by adding an item 1102 indicating a communication state, to the transmission-scheduled data list 1001. In the item 1102, a communication state is written by the communication history management module 308 when data communication is interrupted. The transmission-scheduled data list 1101 having such a structure can be used in the case where the number of management target devices is one, as well as the transmission-scheduled data list 1001 as illustrated in FIG. 10. It should be noted that in place of a numerical value, for example, a unit number or a model number can be used as the number.

Therefore, even in the case where data communication is interrupted, the air-conditioning apparatus 102 in the communication system 100 according to the embodiment can transmit the transmission-scheduled data in the middle of the data communication since the air-conditioning apparatus 102 can use the updated transmission-scheduled data list 801. Thus, the communication system 100 can reduce the communication volume of transmission data, and can reduce the communication time necessary for the transmission data.

It should be noted that the air-conditioning apparatus 102 of the embodiment is also referred to as a transmission device, and the data acquisition device 101 of the embodiment is also referred to as a reception device.

The configurations, etc. of the embodiment are described above by way of example, and these descriptions are not intended to limit the scope of the claims. The embodiment can be put to practical use in various configurations other than the above described ones, and various omissions, substitutions, and modifications can be made without departing from the gist of the embodiment. These configurations and the modifications thereof are covered in the scope and the gist of the embodiment.

### Reference Signs List

1a, 1b, 1n: sensor, 100: communication system, 101: data acquisition device, 102: air-conditioning apparatus, 103: transmission and reception data list, 104: various kinds of data, 200: input module, 201: controller, 202: data operation reception module, 203: data transmission request module, 204: external communication module, 205: list data collation module, 206: list data extraction module, 207: memory, 207_1: communication history data, 207_2: unreceived data list, 207_3: various kinds of data, 208: communication history management module, 209: acquired data management module, 301: controller, 302: external communication module, 303: list data collation module, 304: list data extraction module, 305: memory, 306: data acquisition module, 307: clock module, 308: communication history management module, 309: acquired data management module, 801, 801_1, 901, 901_1, 1001, 1001_1, 1101, 1101_1: transmission-scheduled data list, 802, 902, 1002, 1102: item

1. A transmission apparatus comprising:
a communication module configured to communicate with a reception device through transmission of data; and
a controller configured to process data that is transmitted in communication between the communication module and the reception device,
wherein
the controller is configured to extract data from transmission-scheduled data and produce a transmission-scheduled data list,
the controller is configured to acquire from the reception device, when data communication between the transmission apparatus and the reception device is interrupted and is then recovered, and an interruption history of the communication is present in the reception device, an unreceived data list indicating data that is not received by the reception device before the communication is interrupted,
the controller is configured to combine the acquired unreceived data list with the produced transmission-scheduled data list to update the transmission-scheduled data list, and
the communication module is configured to transmit the updated transmission-scheduled data list to the reception device, and transmit the transmission-scheduled data corresponding to the transmission-scheduled data list to the reception device after transmitting the updated transmission-scheduled data list.

2. The transmission apparatus of claim 1, the transmission apparatus being an air-conditioning apparatus,
wherein the reception device is an information terminal.

3. The transmission apparatus of claim 1 , wherein the controller is configured to delete a list corresponding to the transmitted transmission-scheduled data from the transmission-scheduled data list, after transmitting the transmission-scheduled data.

4. A communication system comprising:
the transmission apparatus of claim 1; and
a reception device configured to communicate with the transmission apparatus through transmission of data.
